(19) United States
(12) Patent Application Publication
(10) Pub. No.: US 2009/0276669 A1
(43) Pub. Date: Nov. 5, 2009

(54) Method for processing and redirecting misdirected advanced shipping notices (ASNs)

(75) Inventors: John M. Hoopes, Washington, IL (US); Shannon M. Pettit, Morton, IL (US); Pauline C. Agbodjan-Prince, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/149,328

(22) Filed: Apr. 30, 2008

(51) Int. Cl. G06F 11/00; G08C 25/02

(52) U.S. Cl. 714/746; 714/748; 715/200; 714/E11.001

(57) ABSTRACT

A method is disclosed for correcting misdirected Advanced Shipping Notices (ASNs). In one embodiment, the method receives, from a product supplier, a first set of data associated with an ASN, where the first set of data includes an ASN receiving facility identifier. The method also determines a Purchase Order (PO) that is associated with the ASN, where the PO includes a second set of data. The method further compares one or more fields of the first set of data with one or more fields of the second set of data. In addition, the method determines if the ASN was misdirected based on the comparison, and corrects the ASN, when it is determined that the ASN was misdirected.

### TECHNICAL FIELD

The present disclosure relates generally to systems and methods for supply chain management, and more particularly, to a system and method for identifying and redirecting misdirected advanced shipping notices.

### BACKGROUND

Businesses often use a coordinated system of organizations, people, activities, information, and resources to move items from point to point. This system is often referred to as a supply chain. Supply chain management is an integral part of any organization that relies on the production, sale, and distribution of products associated with an inventory management environment. Supply chain management refers to any system of processes that allows an organization to control the manufacture and distribution of goods and coordination of services to meet customer requirements for products or services for sale. Businesses that can effectively adapt their supply chain to meet customer expectations while controlling costs may have an increased market position over competitors with less sophisticated supply chain management capabilities. The entities involved in the supply chain typically consist of purchasers and sellers, such as, for example, suppliers, manufacturers, goods and service providers, distributors, sales entities (e.g., wholesale, retail, etc.), end customers, etc.

To manage the supply chain, businesses often use forms and documents (electronic and/or paper) to communicate and track activities in the supply chain. In many businesses, these documents may be sent and/or received electronically using Electronic Data Interchange (EDI). EDI is a commonly used method for the transfer of business transaction data, including the automated purchase of goods and/or services. For example, when a business desires to purchase goods and/or services, the business may use a purchase order (PO). The PO typically indicates the type, quantity, and price of items the business desires to purchase. The PO may also indicate the terms of payment, delivery date, and shipping. When a seller provides goods and/or services to the business, the seller may submit an invoice to the business. The invoice typically indicates the type, quantity, and price of items the seller has provided to the buyer. The invoice may also contain a reference to a corresponding PO, terms of payment, delivery date, and shipping information.

Another document that businesses frequently use in supply chain management is an Advanced Shipping Notice (ASN). An ASN is a notification provided by the seller to the business indicating that a shipment of goods is currently, or soon-to-be, in-transit. The ASN is designed to inform a business of shipments before they arrive at the business location (e.g., distribution center, warehouse, etc.). The ASN contains pertinent information such as the bill of lading number, PO number, shipment information (e.g., weight, quantity, carrier, date of shipment, etc.), receiving facility code, the goods contained in the shipment, etc. By receiving an ASN from its suppliers, a business may realize improved efficiency in the supply chain through reduced receiving time and costs, improved supply chain visibility, improved planning for the receipt of merchandise in a distribution center, etc.

Systems and methods have been created to integrate multiple parties in one supply chain management system or process. One such example is U.S. Patent Application Publication No. 2003/0014270 (the '270 publication) published on Jan. 16, 2003 to Qureshi et al. The '270 publication discloses a data exchange means consisting of an integrated application repository providing data mapping, data translation, and data transactions regardless of the electronic format of data received. In addition, the '270 publication discloses an audit and control means to ensure all data transactions within the system are verified and validated. In addition, the '270 publication discloses process control flows to identify and escalate problem resolution with respect to unsuccessful electronic transactions. According to the '270 publication, data validation includes validating data in incoming transmissions to a buyer for correct transmission information, including correct identification data for one of the suppliers.

Although the system and method of the '270 publication may identify and escalate data transmissions from the suppliers with improper or incorrect supplier information, the system and method do not offer a way to identify advanced shipping notices (ASN) that designate the wrong receiving facility or contain other incorrect buyer related information. Thus, the system of the '270 publication does not provide mechanisms to automatically escalate or flag an ASN sent to the wrong facility for correction or retransmission for a buyer with multiple facilities on multiple networks.

The disclosed embodiments are directed to improvements in the existing technology.

### SUMMARY

In one aspect, the present disclosure is directed to a method for correcting misdirected Advanced Shipping Notices (ASNs). The method receives, from a product supplier, a first set of data associated with an ASN, where the first set of data includes an ASN receiving facility identifier. The method also determines a Purchase Order (PO) that is associated with the ASN, where the PO includes a second set of data. The method further compares one or more fields of the first set of data with one or more fields of the second set of data. In addition, the method determines if the ASN was misdirected based on the comparison, and corrects the ASN, when it is determined that the ASN was misdirected.

In another aspect, the present disclosure is directed to a computer-readable medium, including instructions for performing a method, when executed by a processor, for correcting misdirected ASNs. The method receives, from a product supplier, a first set of data associated with an ASN, where the first set of data includes an ASN receiving facility identifier. The method also determines a PO that is associated with the ASN, where the PO includes a second set of data. The method further compares one or more fields of the first set of data with one or more fields of the second set of data. In addition, the method determines if the ASN was misdirected based on the comparison, and corrects the ASN, when it is determined that the ASN was misdirected.

In another aspect, the present disclosure is directed to a system for correcting misdirected Advanced Shipping Notices (ASNs). The system includes at least one memory storing data and instructions and at least one processor configured to access the memory. The at least one processor is further configured to, when executing instructions, receive, from a products supplier, a first set of data associated with an ASN, where the first set of data includes an ASN receiving facility identifier. The processor is also configured to determine a PO that is associated with the ASN, where the PO includes a second set of data. The processor is further configured to compare one or more fields of the first set of data with one or more fields of the second set of data. The processor is also configured to determine if the ASN was misdirected based on the comparison. The processor is further configured to determine if the correct receiving facility is on the same communications network as an incorrect ASN receiving facility. In addition, the processor is configured to correct a misdirected ASN by changing, when the correct receiving facility is on the same communications network as the incorrect ASN receiving facility, the incorrect ASN receiving facility identifier to a correct receiving facility identifier, and by requesting, when the correct receiving facility is not on the same communications network as the incorrect ASN receiving facility, the product supplier to resend the ASN to the correct receiving facility identified by the correct receiving facility identifier.

### BRIEF DESCRIPTION OF THE DRAWINGS

FIG. 1 is a block diagram of an exemplary inventory management environment consistent with certain disclosed embodiments;

FIG. 2 is a block diagram of an exemplary inventory management system consistent with certain disclosed embodiments;

FIG. 3 is a screenshot of an exemplary ASN Record View form consistent with certain disclosed embodiments;

FIG. 4 is a screenshot of an exemplary Misdirected ASN Record form consistent with certain disclosed embodiments;

FIG. 5 is a screenshot of an exemplary Supplier Record View form consistent with certain disclosed embodiments;

FIG. 6 is a screenshot of an exemplary Misdirected ASN Supplier Summary form consistent with certain disclosed embodiments;

FIG. 7 is a flow chart illustrating an exemplary process for supply chain management and the identification and redirection of misdirected ASNs consistent with certain disclosed embodiments; and

FIG. 8 is a flow chart illustrating an exemplary process for supply chain management and misdirected ASN supplier follow-up consistent with certain disclosed embodiments.

### DETAILED DESCRIPTION

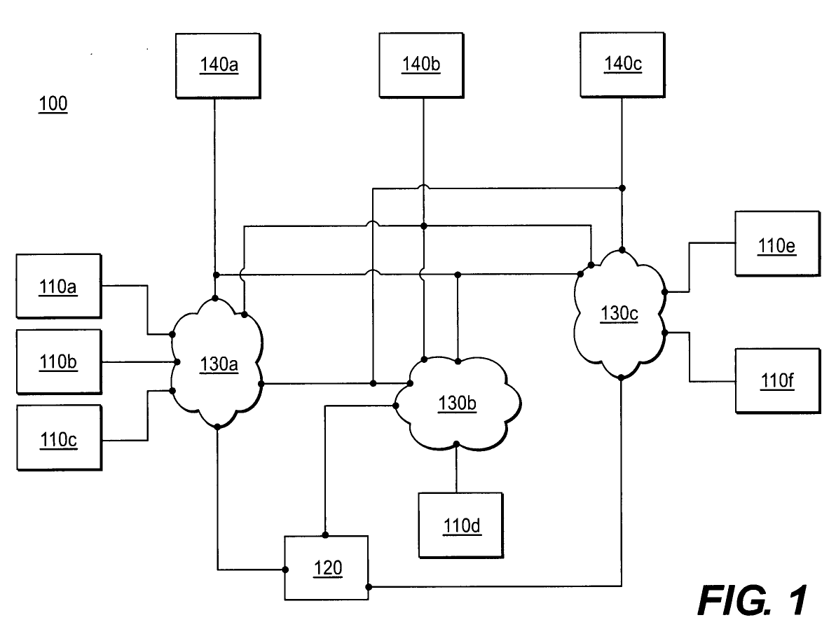

FIG. 1 illustrates an inventory management environment 100 in accordance with certain disclosed embodiments. Inventory management environment 100 may include any environment that comprises a plurality of subsystems that cooperate to manage a supply chain. For example, inventory management environment 100 may include one or more components suitable for monitoring operational aspects associated with a supply chain, analyzing supply chain performance, and reporting data indicative of the supply chain performance to an inventory manager. As illustrated in FIG. 1, inventory management environment 100 may include a plurality of facilities 110a-f for maintaining, storing, and distributing a plurality of products within a supply chain. Inventory management environment 100 may also include an inventory management system 120 communicatively coupled to one or more facilities 110a-f via one or more communications networks 130a-c. Inventory management environment 100 may also include one or more suppliers 140a-c communicatively coupled to one or more facilities 110a-f via one or more communications networks 130a-c.

Facilities 110a-f may each include any type of facility in which a plurality of products may be stored and maintained. Facilities 110a-f may include, for example, a parts depot, a warehouse, a manufacturing center, a product showroom, a document storage facility, a retail center, a regional distribution center, a virtual (e.g., web-based or Internet) retailer, or any other type of facility suitable for storing physical and/or virtual products. Products may include any physical or virtual element that may be used in connection with the performance of a business task. Non-limiting examples of physical products may include raw materials, machines or machine parts or accessories such as, for example, electronic hardware or software, implements, traction devices such as tires, tracks, etc., transmissions, engine parts or accessories, fuel, or any other suitable type of physical product. Non-limiting examples of virtual products may include inventory data, product documentation, software structures, software programs, financial data or documents such as stock records, or any other type of informational or data product.

In one embodiment, facilities 110a-f may be one or more warehouses and/or distribution centers associated with inventory management system 120. In another embodiment, facilities 110a-f may each represent separately owned and/or operated business entities. Alternatively and/or additionally, inventory management system 120 may be managed, owned, and/or operated by a business other than facilities 110a-f and may provide the disclosed embodiments as services to facilities 110a-f. In another exemplary embodiment, facilities 110a-f may be organized into subgroups based on divisions of an organization or lines of business of an organization.

Each product associated with facilities 110a-f may be assigned a purchase order (PO) number when the product is ordered. The PO number may facilitate the tracking of each product through the supply chain. A PO number may include, for example, a numeric, alphabetic, alphanumeric, or symbolic code that may be used to identify and track the product. Inventory management system 120 may maintain a record of each PO.

Inventory management system 120 may include any device or software program configured to monitor and record inventory data associated with inventory management environment 100. For example, the inventory management system 120 may be communicatively coupled to one or more facilities 110a-f via communications network 130a-c. Inventory management system 120 may collect inventory data associated with each facilities 110a-f, monitor and control the flow of inventory between or among each facilities 110a-f, and adapt supply chain resources to ensure the appropriate operation of inventory management environment 100.

Inventory management system 120 may embody a processor-based system on which processes and methods consistent with the disclosed embodiments may be implemented. For example, inventory management system 120 may be a stand-alone computer system on which an inventory management software suite may be installed. Alternatively, inventory management system 120 may include one or more servers, at one or more locations, and the servers may be redundantly deployed to prevent failure. Accordingly, inventory management system 120 (and/or software associated with inventory management system 120) may be configured to collect inventory record data associated with each facility 110a-f, analyze the collected data to determine whether the supply chain is operating appropriately, identify problems associated with the supply chain, isolate possible operational aspects of the supply chain that may be the cause of the problems, and generate a report that summarizes the analysis. Processes and methods associated with inventory management system 120 are described in further detail below.

Communications network 130a-c may include any wired and/or wireless communication system suitable for data transmission such as, for example, satellite, cellular, point-to-point, point-to-multipoint, multipoint-to-multipoint, Bluetooth, RF, Ethernet, fiber-optic, coaxial, and/or waveguide communications. According to one embodiment, communications network 130a-c may include the Internet or a work-site intranet that communicatively connects one or more computer systems associated with divisions or entities of an organization, facilitating data communication between the divisions or entities of an organization. Alternatively and/or additionally, communication networks 130a-c may embody one or more direct data links for communicatively coupling one or more devices directly to inventory management system 120 and may include serial, parallel, USB, Ethernet, fiber-optic, fire-wire, Bluetooth, or any other type of transmission medium suitable for direct transfer of information.

One or more communications network 130a-c may connect one or more facilities 110a-f. In one exemplary embodiment, facilities 110a-c may be on communications network 130a, facility 110d may be on communications network 130b, and facilities 110e-f may be on communications network 130c. Each communications network 130a-c may be connected to inventory management system 120, but an operator at a facility 110a may be limited to interactions with other facilities 110b-c or suppliers 140a-c on the same communications network 130a, and inventory management system 120. In this embodiment, an operator at facility 110a may not be able to interact with facilities 110d-f which are connected on communications networks 130b-c. This may be the case when an organization is composed of facilities 110a-f organized into subgroups based on divisions of an organization or lines of business of an organization or when security requirements require compartmentalization.

Suppliers 140a-c may be connected to inventory management system 120 and one or more facilities 110a-f through one or more communications networks 130a-c. Suppliers 140a-c may be any business or other entity that sells or provides goods to one or more other entities. In one exemplary embodiment, suppliers 140a-c may provide goods to one or more facilities 110a-f. In a further exemplary embodiment, suppliers 140a-c may only sell or provide goods to facilities 110a-f after receipt of a PO. In another exemplary embodiment, suppliers 140a-c and facilities 110a-f are all part of the same business or organization.

Suppliers 140a-c and facilities 110a-f may each include one or more computing devices (i.e., desktop, laptop, mainframe, server, client, handheld computing device, personal digital assistant, telephony device, tablet PC, bar code reader, scanner, etc.) and various other hardware and/or software components (not shown). The one or more computing devices may allow suppliers 140a-c and facilities 110a-f to connect to and communicate with inventory management system 120 by means of one or more communications networks 130a-c. The one or more computing devices may also allow suppliers 140a-c and facilities 110a-f to connect to and communicate with one or more other suppliers 140a-c and facilities 110a-f by means of communications network 130a-c.

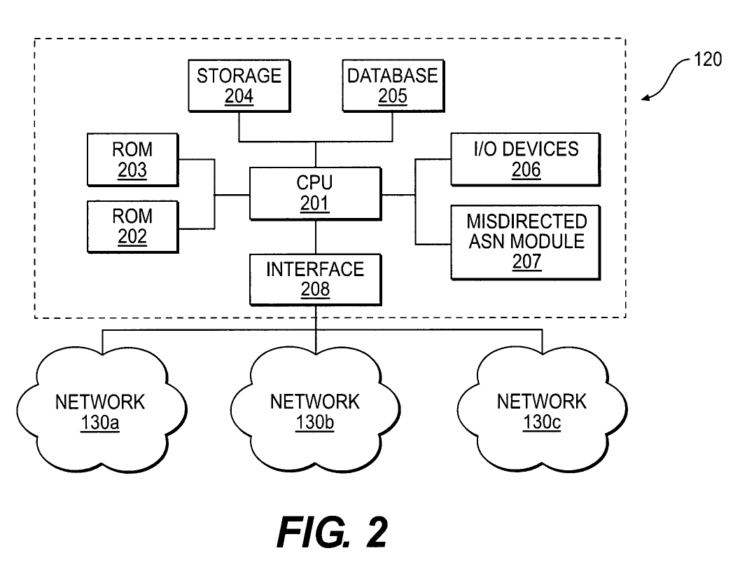

FIG. 2 provides a block diagram of an exemplary inventory management system 120 of FIG. 1. FIG. 2 illustrates an exemplary inventory management system 120 that may be configured to receive, collect, analyze, evaluate, report, display, and distribute data related to supply chain management and ASNs using one or more hardware and/or software components. For example, inventory management system 120 may include one or more of a central processing unit (CPU) 201, a random access memory (RAM) 202, a read-only memory (ROM) 203, a storage system 204, a database 205, one or more input/output (I/O) devices 206, misdirected ASN module 207, and an interface 208. Inventory management system 120 may be a server, client, mainframe, desktop, laptop, network computer, workstation, personal digital assistant (PDA), tablet PC, scanner, telephony device, pager, etc. In one embodiment, inventory management system 120 may be a computer configured to receive and process information associated with the supply chain, including POs, invoices, ASNs, etc.

CPU 201 may include one or more processors, each configured to execute instructions and process data to perform one or more functions associated with inventory management system 120. As illustrated in FIG. 2, CPU 201 may be communicatively coupled to RAM 202, ROM 203, storage system 204, database 205, one or more I/O devices 206, misdirected ASN module 207, and interface 208. CPU 201 may be configured to execute computer program instructions to perform various processes and methods consistent with certain disclosed embodiments. In one exemplary embodiment, computer program instructions may be loaded into RAM 202 for execution by CPU 201.

RAM 202 and ROM 203 may each include one or more devices for storing information associated with an operation of inventory management system 120 and/or CPU 201. For example, ROM 203 may include a memory device configured to access and store information associated with inventory management system 120, including information for identifying, initializing, and monitoring the operation of one or more components and subsystems of inventory management system 120. RAM 202 may include a memory device for storing data associated with one or more operations of CPU 201. For example, instructions stored on ROM 203 may be loaded into RAM 202 for execution by CPU 201.

Storage system 204 may include any type of storage device configured to store any type of information used by CPU 201 to perform one or more processes consistent with the disclosed embodiments. For example, storage system 204 may include one or more magnetic and/or optical disk devices, such as, for example, hard drives, CD-ROMs, DVD-ROMs, a universal serial bus (USB) port, a floppy, or any other type of mass media device.

Database 205 may include one or more software and/or hardware components that store, organize, sort, filter, and/or arrange data used by inventory management system 120 and/or CPU 201. For example, database 205 may store one or more tables, lists, or other data structures containing data associated with supply chain management and automated detection of misdirected ASNs. In a further example, database 205 may store information associated with supply chain management, such as, for example, data associated with POs, invoices, ASNs, one or more suppliers 140a-c, one or more shippers, one or more facilities 110a-f, one or more distribution centers, freight and/or shipping data, as well as shipments received to, from, and/or between the aforementioned entities, etc., that may be used by CPU 201 to receive, categorize, prioritize, save, send, or otherwise manage data associated with the supply chain and automated detection of misdirected ASNs. In addition, database 205 may store additional and/or different information than that listed above.

I/O devices 206 may include one or more components configured to communicate information associated with inventory management system 120. For example, I/O devices 206 may include a console with an integrated keyboard and mouse to allow a user to input parameters associated with inventory management system 120 and/or data associated with the supply chain, supply chain management, supply chain discrepancies, and the automated detection of misdirected ASNs. I/O devices 126 may also include a display including a graphical user interface (GUI) for outputting information on a monitor. I/O devices 206 may include one or more displays or other peripheral devices, such as, for example, printers, cameras, disk drives, microphones, speaker systems, electronic tablets, bar code readers, scanners, or any other suitable type of I/O device 206.

Misdirected ASN module 207 may include one or more software programs, instructions, and/or listings configured to perform processes consistent with certain disclosed embodiments. For example misdirected ASN module 207 may include a computer program product stored on inventory management system 120 and configured to be executed by CPU 201 to perform one or more processes for receiving and processing information associated with the supply chain and automated detection of misdirected ASNs. Interface 208 may include one or more components configured to transmit and receive data via communications networks 130a-c, such as, for example, one or more modulators, demodulators, multiplexers, de-multiplexers, network communication devices, wireless devices, antennas, modems, and any other type of device configured to enable data communication via any suitable communications networks 130a-c. In some exemplary embodiments, interface 208 may be connected to multiple communications networks 130a-c. Interface 208 may also be configured to provide remote connectivity between CPU 201, RAM 202, ROM 203, storage system 204, database 205, one or more input/output (I/O) devices 206, and/or Misdirected ASN module 207 to collect, analyze, and distribute data or information associated with the supply chain and supply chain management.

Inventory management system 120 may include additional, fewer, and/or different components than those listed above and it is understood that the listed components are exemplary only and not intended to be limiting. For example, one or more of the hardware components listed above may be implemented using software. In one exemplary embodiment, storage system 204 may include a software partition associated with one or more other hardware components of inventory management system 120. Additional hardware or software may also be used to operate inventory management system 120, such as, for example, security applications, authentication systems, dedicated communication systems, etc. The hardware and/or software may be interconnected and accessed as required by authorized users. In addition, a portion, or all of, inventory management system 120 may be hosted and/or operated offsite using, for example, commercial servers, commercial application providers, etc.

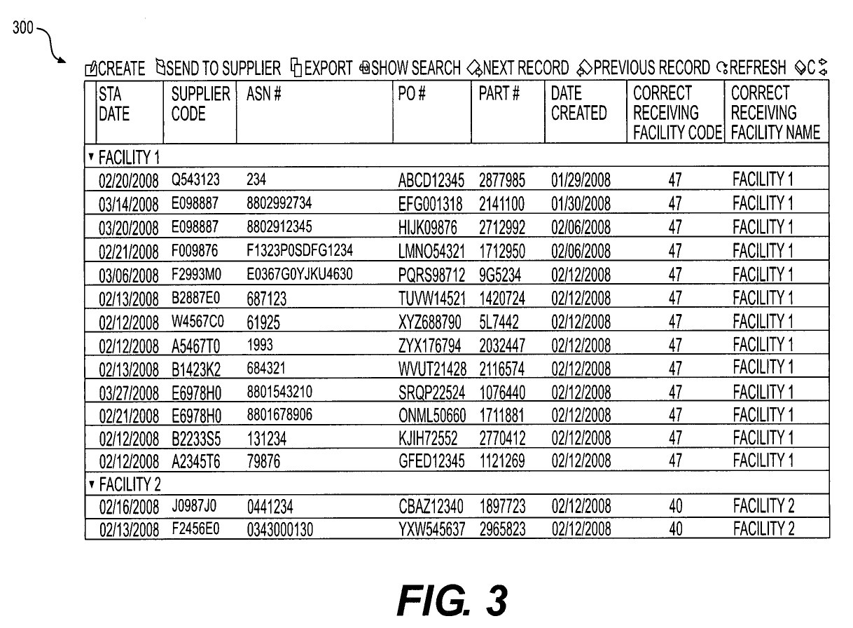

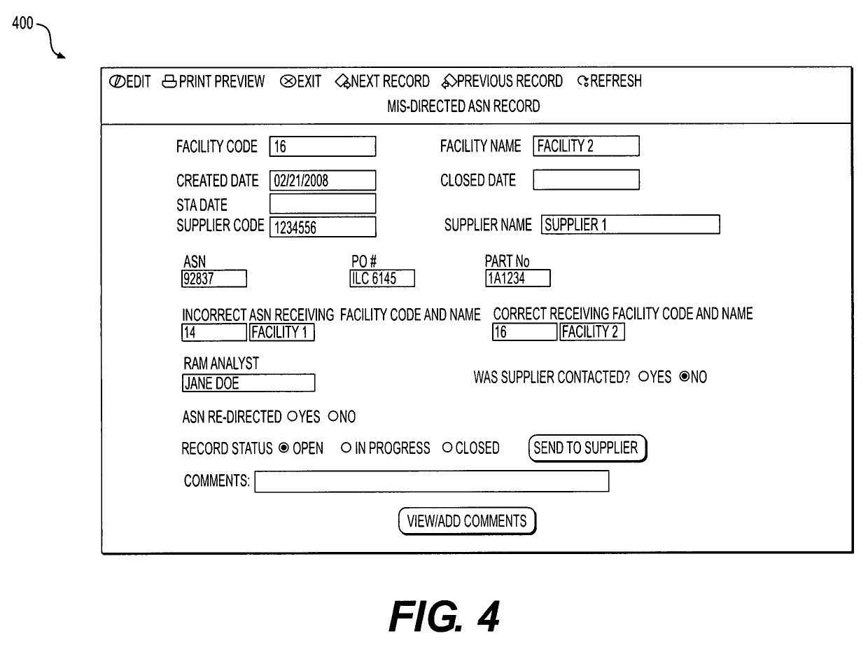

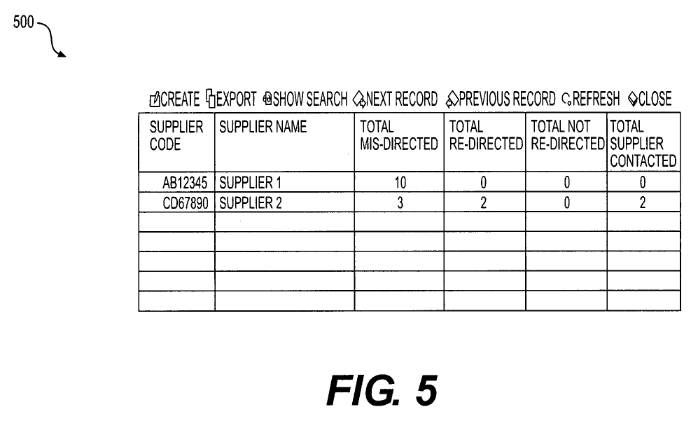

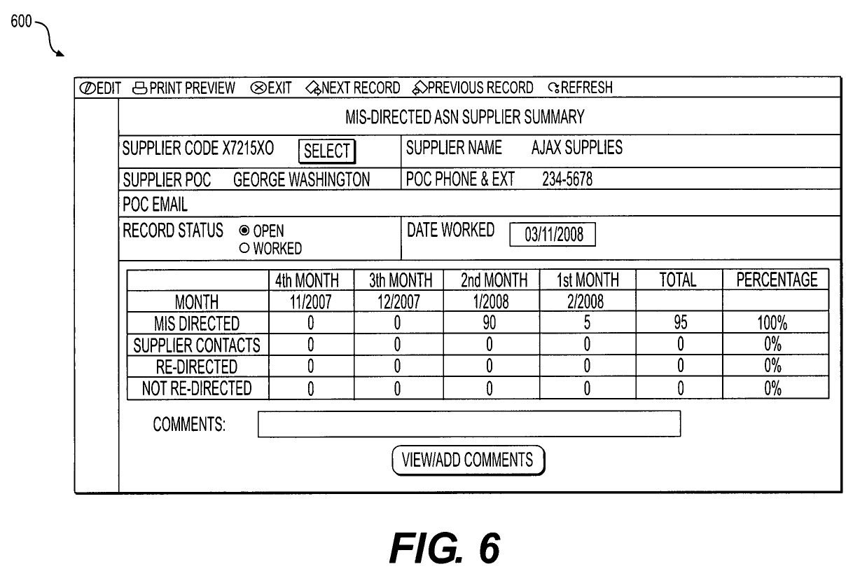

Misdirected ASN module 207 may include one or more electronic forms and/or documents to perform one or more processes consistent with certain disclosed embodiments. The electronic forms may provide data stored in database 205 of inventory management system 120. In certain embodiments, the data may be edited, added, and/or removed by a user or software process. In addition, the electronic forms may provide mechanisms for storing data associated with supply chain management and automated detection of misdirected ASNs. In one embodiment, misdirected ASN module 207 may access database 205 to retrieve and/or store data associated with the one or more electronic forms. The electronic forms may include, for example, a ASN Record View form 300 (FIG. 3), Misdirected ASN Record form 400 (FIG. 4), Supplier Record View form 500 (FIG. 5), and Misdirected ASN Supplier Summary form 600 (FIG. 6), etc. The forms discussed in FIGS. 3, 4, 5, and 6 and implemented by the disclosed embodiments are exemplary. The forms implemented by the disclosed embodiments may include fewer or more forms, different types of forms, and/or different fields or data.

In one embodiment, ASN Record View form 300, Misdirected ASN Record form 400, Supplier Record View form 500, and/or Misdirected ASN Supplier Summary form 600 may be accessed, edited, and stored by one or more authorized users. An authorized user may be any agent, employee, and/or other persons or entities authorized to view and/or edit data associated with supply chain management, including agents, employees, and/or other persons or entities associated with inventory management system 120 and facilities 110a-f. For example, the one or more authorized users may include one or more persons or entities who may be responsible for maintaining supply management data and discrepancy records, one or more persons or entities who may be responsible for determining and providing data associated with item receipt, one or more persons or entities who may be responsible for independent tracking and verification of data and discrepancy record management, one or more persons or entities who may be responsible for providing data associated with the supply chain, one or more persons or entities who may be responsible for maintaining records for themselves and others, one or more persons or entities who may require access to data associated with supply chain management, etc.

As discussed above, FIG. 3 shows an exemplary ASN Record View form 300, and FIG. 4 shows an exemplary Misdirected ASN Record form 400. ASN Record View form 300 and/or Misdirected ASN Record form 400 may be used to track and investigate discrepancies between ASNs and POs, such as, for example, different receiving facility codes. In addition, ASN Record View form 300 and/or Misdirected ASN Record form 400 may be configured to allow data associated with discrepancies between ASNs and POs to be added or deleted. In certain disclosed embodiments, misdirected ASN module 207 may retrieve data from database 205 and insert the data in ASN Record View form 300 and/or Misdirected ASN Record form 400 for display and/or editing by one or more authorized users. For example, one or more authorized users may update one or more data fields of ASN Record View form 300 and/or Misdirected ASN Record form 400, and may save the edited data to database 205. Additionally, one or more authorized users may use Misdirected ASN Record form 400 to print the currently displayed discrepancy data by selecting “Print.”

In one embodiment, ASN Record View form 300 and/or Misdirected ASN Record form 400 may be configured to provide a different subset of the entire data set associated with the forms depending on the identity of the entity attempting to access the data. For example, ASN Record View form 300 and/or Misdirected ASN Record form 400 may provide a first subset of data to a user based on their authorization. As shown in FIGS. 3 and 4, the first subset of data may include, for example, supplier code, ASN number, PO number, part number, supplier name, ASN receiving facility code (i.e., code of facility receiving the ASN), ASN receiving facility name, correct receiving facility code (i.e., code of facility receiving the shipment), correct receiving facility name, etc. The first subset of data may be limited to certain facilities 110a-f or to certain communications networks 130a-c. In addition, misdirected ASN module 207 may provide a second subset of data using ASN Record View form 300 and/or Misdirected ASN Record form 400 to a first set of users, such as, for example, information associated with an individual or group responsible for resolution (e.g., name and/or contact information, etc.), resolution information, etc., as shown in FIG. 4. Additionally, misdirected ASN module 207 may provide a third subset of data that covers all facilities 110a-f and/or communications networks 130a-c to a second set of users. Although only three subsets of data are disclosed, misdirected ASN module 207 may provide fewer or greater number of subsets of data to other authorized users.

As discussed above, FIG. 5 shows an exemplary Supplier Record View form 500 and FIG. 6 shows an exemplary Misdirected ASN Supplier Summary form 600. Supplier Record View form 500 and/or Misdirected ASN Supplier Summary form 600 may be used to track and investigate suppliers associated with discrepancies between ASNs and POs, and to trend and analyze a supplier's number of mistakes, correctly sent ASNs, accuracy, and to examine the categories by time periods. In addition, Supplier Record View form 500 and/or Misdirected ASN Supplier Summary form 600 may be configured to allow data associated with discrepancies between ASNs and POs to be added or deleted. In certain disclosed embodiments, misdirected ASN module 207 may retrieve data from database 205 and insert the data in Supplier Record View form 500 and/or Misdirected ASN Supplier Summary form 600 for display and/or editing by one or more authorized users. For example, one or more authorized users may update one or more data fields of Supplier Record View form 500 and/or Misdirected ASN Supplier Summary form 600 and may save the edited data to database 205. Additionally, one or more authorized users may use Misdirected ASN Supplier Summary form 600 to print the currently displayed discrepancy data by selecting “Print.”

In one embodiment, Supplier Record View form 500 and/or Misdirected ASN Supplier Summary form 600 may be configured to provide a different subset of the entire data set associated with the forms depending on the identity of the entity attempting to access the data. For example, Supplier Record View form 500 and/or Misdirected ASN Supplier Summary form 600 may provide a first subset of data to a user based on their authorization. As shown in FIGS. 5 and 6, the first subset of data may include, for example, supplier code, supplier name, number misdirected, number redirected, number not redirected, number of supplier contacts, supplier POC, etc. The first subset of data may be limited to certain facilities 110a-f or to certain communications networks 130a-c. In addition, misdirected ASN module 207 may provide a second subset of data using Supplier Record View form 500 and/or Misdirected ASN Supplier Summary form 600 to a first set of users, such as, for example, information associated with an individual or group responsible for resolution (e.g., name and/or contact information, etc.), resolution information, numbers broken down by months, percentages, etc., as shown in FIG. 6. Additionally, misdirected ASN module 207 may provide a third subset of data that covers all facilities 110a-f and/or communications networks 130a-c to a second set of users. Although only three subsets of data are disclosed, misdirected ASN module 207 may provide fewer or additional subsets of data to other authorized users.

In addition to ASN Record View form 300, Misdirected ASN Record form 400, Supplier Record View form 500, and Misdirected ASN Supplier Summary form 600, additional forms and/or compilations of the underlying records associated with the forms may be provided. For example, Misdirected ASN module 207 may provide a list of records associated with ASN Record View form 300, Misdirected ASN Record form 400, Supplier Record View form 500, and Misdirected ASN Supplier Summary form 600 such that one or more authorized users may view a list of records associated with the forms. The list of records may be sorted, for example, based on divisions of an organization or lines of business of an organization. The authorized user may select one or more records for viewing and/or editing. The list of records may include only a portion of the data contained in the records, such as, for example, a record number, a PO number, an ASN number, etc.

In some embodiments, inventory management system 120 may be configured to automatically process one or more records to generate a list of records. The list of records may be processed based on a predetermined event (e.g., regularly scheduled time intervals, specified number of records having a certain priority, records for inventory items having a specified dollar amount, sales volume, and/or velocity [i.e., rate at which an item is sold], etc.). In one exemplary embodiment, inventory management system 120 may process a list of records on a daily basis. In another embodiment, inventory management system 120 may process a list of records at periodic hourly intervals when a record associated with a high value inventory item is included in the list of records. Alternatively and/or additionally, inventory management system 120 may process a list of records when prompted, requested, instructed, or otherwise directed by an authorized user. In addition, the user may select one or more records from the list of records for viewing or editing. A selected record may be displayed using ASN Record View form 300 and/or Misdirected ASN Record form 400.

In addition, misdirected ASN module 207 may be configured to automatically manage the one or more records stored in database 205 as the records are processed. Misdirected ASN module 207 may manage the records based on data values stored in the records or in ASN Record View form 300, Misdirected ASN Record form 400, Supplier Record View form 500, and/or Misdirected ASN Supplier Summary form 600. For example, misdirected ASN module 207 may evaluate one or more fields in the record and, based on the data values stored in the fields, may automatically perform one or more predetermined actions. For example, notifying one or more users of required and/or expected actions, sending electronic notifications to one or more users, sending electronic alerts and reminder to users, inputting data into one or more fields of the records, determining a required or desired next action towards resolution of one or more discrepancies, controlling access and/or visibility to individual records and/or forms and lists of records and forms, controlling access and/or visibility to ASN Record View form 300, Misdirected ASN Record form 400, Supplier Record View form 500, and/or Misdirected ASN Supplier Summary form 600, controlling access and/or visibility to data fields of ASN Record View form 300, Misdirected ASN Record form 400, Supplier Record View form 500, and Misdirected ASN Supplier Summary form 600, etc.

As discussed above, misdirected ASN module 207 may be configured to control access to ASN Record View form 300, Misdirected ASN Record form 400, Supplier Record View form 500, and/or Misdirected ASN Supplier Summary form 600, as well as the list of records associated with those forms. In addition, misdirected ASN module 207 may control access to data fields, buttons, etc. within ASN Record View form 300, Misdirected ASN Record form 400, Supplier Record View form 500, and/or Misdirected ASN Supplier Summary form 600. Misdirected ASN module 207 may control access to data fields in the records and/or forms such as, for example, PO numbers, ASN numbers, part number, ASN receiving facility code, correct receiving facility code, etc. For example, misdirected ASN module 207 may restrict access to forms and/or records based on the identity of the user viewing the form, such that only an authorized user may view and/or alter the forms and/or records.

Additionally, misdirected ASN module 207 may control activation of one or more buttons in Misdirected ASN Record form 400 and Misdirected ASN Supplier Summary form 600, and only allow editing or entry of data based upon the status of the record. For example, misdirected ASN module 207 may enable activation of buttons and/or editing of data when a record status is unresolved. Misdirected ASN module 207 may disable activation of buttons to prevent editing or entry of data when a record status is resolved. For instance, when a record is created, misdirected ASN module 207 may automatically generate and send one or more notifications to one or more authorized users. Misdirected ASN module 207 may automatically determine the recipients of the notification based on data contained in one or more data fields of the record, such as, for example, PO numbers, ASN numbers, part number, ASN receiving facility code, correct receiving facility code, days since report created, etc. Notification may be electronically generated using, for example, electronic mail, instant message, electronic page, telephony contact, and similar types of electronic notification mechanisms.

Misdirected ASN module 207 may automatically evaluate one or more data fields in the records to determine one or more further actions. For example, if the “start date” field is selected in an open discrepancy report, the current date and time may be automatically entered. In addition, responsibility for the discrepancy record may be assigned and the associated data may be automatically entered or updated, including, for example, name and phone number of a responsible party, etc. The responsible party may be one or more individuals assigned to track resolution of the form and/or record.

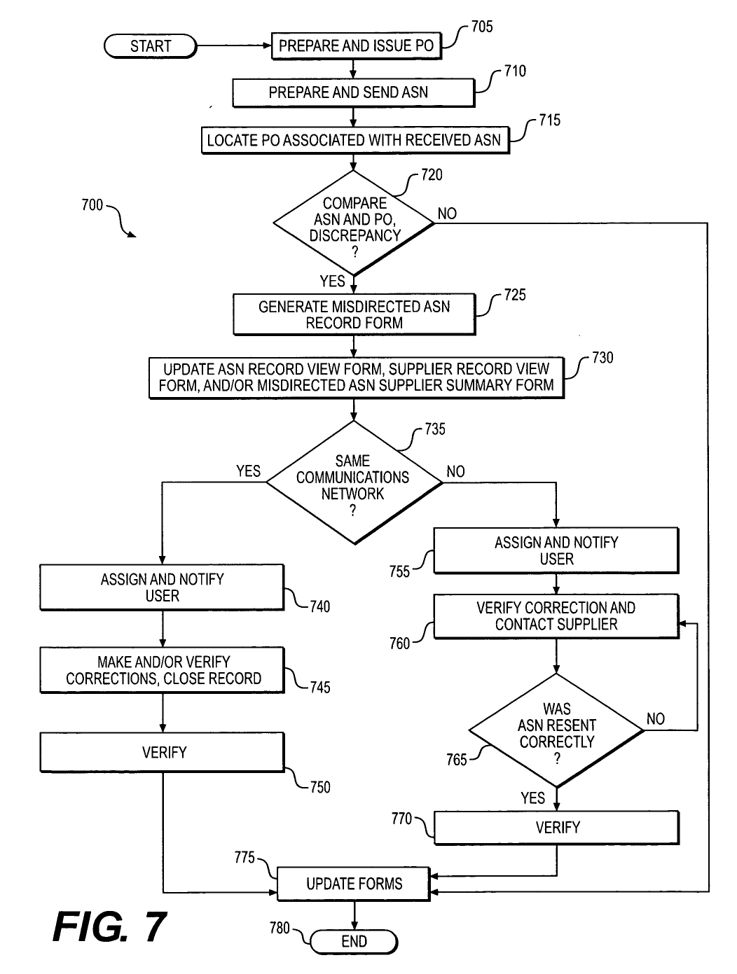

FIG. 7 illustrates a flowchart 700 of an exemplary process for supply chain management and automated detection of misdirected ASNs consistent with certain disclosed embodiments. The process of FIG. 7 may be performed by inventory management system 120. For example, inventory management system 120 may execute one or more software programs that may perform one or more of the process steps of FIG. 7.

In step 705 inventory management system 120 may prepare and issue a PO. The PO may be sent to a specified supplier 140a-c, e.g., supplier 140a, using electronic means, such as, for example, email, electronic data interchange (EDI), ftp, telnet, fax, etc. Alternatively and/or additionally, the PO may be sent to supplier 140a-c via paper-based means, such as, for example, mail, fax, courier, or the like. As discussed above, the PO may indicate the type, quantity, and price of items to be purchased from supplier 140a-c, as well as the terms of payment, delivery date, and shipping, including shipping destination. In addition, inventory management system 120 may store the data corresponding to the PO in database 205.

In step 710, once supplier 140a-c is prepared to ship one or more items associated with the PO, supplier 140a-c may prepare and send an ASN. The ASN may be sent using electronic means, such as, for example, email, electronic data interchange (EDI), ftp, telnet, etc., and may be received by inventory management system 120. Alternatively, the ASN may be sent via paper-based means, such as, for example, mail, fax, etc. In some embodiments, if the ASN is sent via a paper-based means, data contained in the ASN may be converted into an electronic format. For example, data contained in a mailed ASN may be converted and stored as electronic data in inventory management system 120 using, for example, manual data entry, optical character recognition, etc. In either case, the ASN may be sent to inventory management system 120 prior to, simultaneous with, or subsequent to shipment of the one or more items associated with the ASN. As discussed above, the ASN may contain information such as the bill of lading number, PO number, shipment information (e.g., weight, quantity, carrier, date of shipment, etc.), receiving facility code, and a list of goods contained in the shipment. In some embodiments, if the shipment is correct and complete and the information contained in the ASN is accurate and complete, the data contained in the ASN may mirror the data contained in the PO. In an exemplary embodiment, the ASN may be sent in compliance with the ANSI 12.x standard as an EDI 856 message. In other embodiments, the ASN may be sent to facility 110a-f. Facility 110a-f may then forward the ASN to inventory management system 120.

In step 715, when inventory management system 120 receives an ASN, inventory management system 120 may locate a PO associated with the received ASN in database 205. For example, inventory management system 120 may parse the data included in the ASN to determine the number of the associated PO. Inventory management system 120 may then access database 205 to locate the stored data associated with the PO number.

In step 720, misdirected ASN module 207 of inventory management system 120 may automatically compare the data included in the ASN and the data included in the PO with one another to determined if there is a discrepancy in the data. In one embodiment, misdirected ASN module 207 may compare determined fields of data, such as, for example, receiving facility code, item number, item quantity, etc. As discussed above, if both the ASN data and the contents of the shipment are correct and complete, then certain determined data contained in the ASN and the PO may be identical. The certain determined data may include, for example, receiving facility code, the type and quantity of items included in the shipment, item number, price, etc. If there is a discrepancy between the receiving facility code in the ASN and the PO, step 725 may be executed next, otherwise step 775 may be executed.

In step 725, if there is a discrepancy between the receiving facility code included in the ASN and the receiving facility code included in the PO, misdirected ASN module 207 may generate a Misdirected ASN Record form 400. Misdirected ASN Record form 400 may be a text or binary file consisting of data associated with the incorrect ASN receiving facility codes and may be stored in database 205.

In addition, in step 730, ASN Record View form 300, Supplier Record View form 500, and/or Misdirected ASN Supplier Summary form 600 may be updated to include information about the new Misdirected ASN Record form 400 that was created. Such information may include the date, supplier code, ASN number, PO number, date created, incorrect ASN receiving facility code, correct receiving facility code, supplier name, incrementing the number misdirected ASNs, etc. If there is no Misdirected ASN Supplier Summary form 600 for the supplier code, a new Misdirected ASN Supplier Summary form 600 may be created and populated with data from the PO, the ASN, and/or database 205.

Also, Misdirected ASN Record form 400 may be parsed by misdirected ASN module 207 to enable user-interaction such that a user may display, track, and/or edit Misdirected ASN Record form 400 using one or more electronic forms (e.g., ASN Record View form 300, etc.). Misdirected ASN Record form 400 may contain information, such as, for example, supplier code, supplier contact information, ASN number, PO number, part number, supplier name, incorrect ASN receiving facility code, incorrect ASN receiving facility name, correct receiving facility code, correct receiving facility name, etc.

In step 735, inventory management system 120 may determine if the incorrect ASN receiving facility code and the correct receiving facility code are on the same communications network 130a-c, or if there is some other reason the ASN must be resent, and cannot be corrected by the authorized user. If the incorrect and correct receiving facilities are on the same communications network 130a-c, and the ASN can be corrected without being resent by supplier 140a-c, then step 740 may be performed next. If the incorrect and correct receiving facilities are on different communications network 130a-c, or the ASN cannot be corrected without being resent by supplier 140a-c, then step 755 may be performed next.

In step 740, misdirected ASN module 207 may assign Misdirected ASN Record form 400 to one or more authorized users and may send a notification to those one or more authorized users when a new Misdirected ASN Record form 400 is created. Authorized users may be assigned based on certain determined fields, such as, for example, supplier code, facility codes, ASN number, PO number, etc. Notifications may be electronically generated using, for example, electronic mail, instant message, electronic page, telephony contact, and similar types of electronic notification mechanisms. Sending a notification to authorized users may include notification of required and/or expected actions, and/or sending electronic alerts and reminders to authorized users.

In step 745, the authorized users may make and/or verify the corrections, and close the matter. In one exemplary embodiment, ASN Record View form 300 may be used by the authorized user to bring up Misdirected ASN Record form 400 or the corrections may be made on ASN Record View form 300. In another exemplary embodiment, the corrections may only be made on Misdirected ASN Record form 400. Misdirected ASN Record form 400 may suggest the correct receiving facility code and name based on information contained in the PO. The authorized user may be able to accept or change the correct receiving facility code. In one exemplary embodiment, the authorized user may be able to open a copy of the PO.

In step 750, misdirected ASN module 207 may monitor Misdirected ASN Record form 400, and at certain determined intervals before the parts arrival date, may verify the matter is closed, the receiving facility codes are correct, and the ASN was reassigned to the correct facility 110a-f. Inventory management system 120 may send, at certain determined intervals before the parts arrival date, a notification to authorized users when a Misdirected ASN Record form 400 has not been closed. Once misdirected ASN module 207 determines Misdirected ASN Record form 400 has been closed, step 775 may then be executed.

When the incorrect and correct receiving facilities are on different communications network 130a-c, or the ASN cannot be corrected without being resent by supplier 140a-c, step 755 may be performed after step 735. In step 755, misdirected ASN module 207 may assign Misdirected ASN Record form 400 to one or more authorized users and send a notification to those one or more authorized users when a new Misdirected ASN Record form 400 is created. Authorized users may be assigned based on certain determined fields, such as, for example, supplier code, facility codes, ASN number, PO number, etc. Notifications may be electronically generated using, for example, electronic mail, instant message, electronic page, telephony contact, and similar types of electronic notification mechanisms. Sending a notification to authorized users may include notification of required and/or expected actions, and/or sending electronic alerts and reminders to authorized users.

In step 760, the authorized users may verify the correction to be made, and contact the supplier 140a-c to resend the ASN. In one exemplary embodiment, ASN Record View form 300 may be used by the authorized user to bring up Misdirected ASN Record form 400 or the corrections may be verified and contact of supplier 140a-c initiated from ASN Record View form 300. In another exemplary embodiment, the corrections may only be verified and contact of supplier 140a-c initiated from Misdirected ASN Record form 400. Misdirected ASN Record form 400 may suggest the correct receiving facility code and correct receiving facility name based on information contained in the PO. In one exemplary embodiment, the authorized user may be able to open a copy of the PO.

In step 765, misdirected ASN module 207 may monitor if the ASN was resent with the correct receiving facility code. If the ASN is not resent within a certain determined time of the parts arrival date, misdirected ASN module 207 may send a notification to authorized users that a corrected ASN has not been sent by supplier 140a-c. The authorized user may be directed to initiate the actions of step 760 again to require the supplier 140a-c to resend a corrected ASN. If a corrected ASN is received from supplier 140a-c, step 770 may be next executed.

In step 770, misdirected ASN module 207 may monitor Misdirected ASN Record form 400, and at certain determined intervals before the parts arrival date, may verify the ASN was resent with the correct receiving facility code. Once misdirected ASN module 207 determines Misdirected ASN Record form 400 has been closed, step 775 may then be executed.

In step 775, once the Misdirected ASN Record form 400 is closed, misdirected ASN module 207 may update ASN Record View form 300, Supplier Record View form 500, and/or Misdirected ASN Supplier Summary form 600 to include information about the closed Misdirected ASN Record form 400. Such information may include the date, supplier code, ASN number, PO number, date created, ASN receiving facility code, correct receiving facility code, supplier name, incrementing the number misdirected ASNs, incrementing the number re-directed ASNs, supplier contacts, etc. Once the matter is closed and the forms updated, in step 780, flowchart 700 may end.

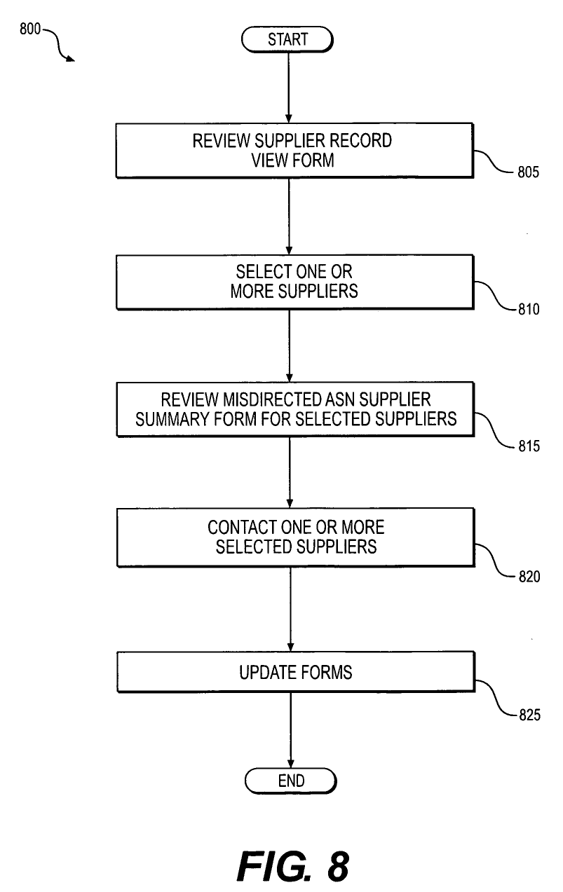

FIG. 8 illustrates a flowchart 800 of an exemplary process for supply chain management and misdirected ASN supplier follow-up consistent with certain disclosed embodiments. The process of FIG. 8 may be performed by inventory management system 120. For example, inventory management system 120 may execute one or more software programs that may perform one or more of the process steps of FIG. 8.

In step 805, the authorized user reviews Supplier Record View form 500. Misdirected ASN module 207 may maintain Supplier Record View form 500, and Supplier Record View form 500 may be stored on database 205. Supplier Record View form 500 may sort suppliers 140a-c based on number of misdirected ASNs, or other criteria.

In step 810, the authorized user may select one or more suppliers 140a-c based on one or more criteria to review their Misdirected ASN Supplier Summary form 600. Criteria may include, for example, a high number of misdirected ASNs, any misdirected ASNs, above a determined number of misdirected ASNs, etc. Once the list of Misdirected ASN Supplier Summary forms 600 to be reviewed are selected, for each selected suppliers 140a-c, step 815 and 820 may be executed.

In step 815, authorized user reviews Misdirected ASN Supplier Summary form 600 for the one or more selected suppliers 140a-c. The authorized user may look at frequency of misdirected ASNs, if there has been an increase in the number per month since the last review, changes in the month to month pattern, the number of previous supplier 140a-c contacts, any comments from previous contacts with supplier 140a-c, etc. Based on this information, the authorized user may develop an understanding of the sort of errors being made by one or more suppliers 140a-c.

In step 820, authorized user may contact one or more selected suppliers 140a-c and discuss how to reduce the frequency of misdirected ASNs. Authorized user may use the understanding developed in step 815 for each of the one or more selected suppliers 140a-c. Authorized user may develop a plan to reduce misdirected ASNs with each of the one or more selected suppliers 140a-c. Such a plan may include scheduled review of progress in reducing mid-directed ASNs.

In step 825, authorized user may update Misdirected ASN Supplier Summary form 600 to include all actions taken for each of the one or more suppliers 140a-c contacted, and any follow up contacts or reviews to be performed. When Misdirected ASN Supplier Summary form 600 is updated, misdirected ASN module 207 may update Supplier Record View form 500 with information in Misdirected ASN Supplier Summary form 600.

### INDUSTRIAL APPLICABILITY

Although the disclosed embodiments may be implemented with processes involving supply chain management, they may applicable to any environment where it may be advantageous to minimize misdirected replies to requests. The disclosed embodiments may achieve improved processing for sending and receiving goods between a business and its suppliers. In particular, the disclosed embodiments may provide improved data input, tracking, and auditing of supply chain documents, including invoices, POs, and ASNs, as well as resolving misdirected ASNs before the parts are delivered.

In addition, the disclosed embodiments may be used within a business entity. The business entity may include divisions, groups, lines of business, etc. that interact as sub-entities for the business entity. The sub-entities may act as a purchaser of a good supplied by a supplier sub-entity within the same business entity, such as a manufacturing business with supply division, production line division, shipping division, etc.

The presently disclosed systems and methods for automated detection of misdirected ASNs may increase supply chain reliability and efficiency. For example, the systems and methods described herein are configured to automatically detect a misdirected ASN, determine the likely correct facility 110a-f, and provide an automatic notification to an authorized user to review and close any created reports. Accordingly, the presently disclosed systems and methods may enable inventory managers and logistics providers to quickly isolate problematic sources of misdirected ASNs, and take actions to mitigate these problems. Additionally, because the presently disclosed systems may require less investigation on the part of inventory managers to isolate and fix misdirected ASNs, inventory management time and resources may be more appropriately directed toward providing long-term solutions for correcting supply chain errors that cause misdirected ASNs.

Also, the disclosed systems and methods for automated detection of misdirected ASNs, may detect and correct ASNs before the products are received at the correct receiving facility. When the ASN is corrected before products are received, the accounting system and inventory management system 120 may reduce the introduction of errors, and decrease the cost of corrections, especially if additional manual actions are required.

It will be apparent to those skilled in the art that various modifications and variations can be made in the system and method of supply chain management and automated detection of misdirected ASNs. Other embodiments of the present disclosure will be apparent to those skilled in the art from consideration of the specification and practice of the present disclosure. It is intended that the specification and examples be considered as exemplary only, with a true scope of the disclosed embodiments being indicated by the following claims.

What is claimed is:

1. A method for correcting misdirected Advanced Shipping Notices (ASNs), comprising:
receiving, from a product supplier, a first set of data associated with an ASN, wherein the first set of data includes an ASN receiving facility identifier;
determining a purchase order (PO) that is associated with the ASN, wherein the PO includes a second set of data;
comparing one or more fields of the first set of data with one or more fields of the second set of data;
determining if the ASN was misdirected based on the comparison; and
correcting the ASN, when it is determined that the ASN was misdirected.

2. The method as in claim 1, wherein correcting the ASN is completed before delivery of material associated with the ASN.

3. The method of claim 1, wherein when it is determined that the ASN was misdirected to an incorrect ASN receiving facility, correcting the ASN further includes:
determining if a correct receiving facility, identified by a correct receiving facility identifier, is on the same communications network as an incorrect ASN receiving facility identified by an incorrect ASN receiving facility identifier;
changing, when the correct receiving facility is on the same communications network as the incorrect ASN receiving facility, the incorrect ASN receiving facility identifier to the correct receiving facility identifier; and
requesting, when the correct receiving facility is not on the same communications network as the incorrect ASN receiving facility, the product supplier to resend the ASN to the correct receiving facility identified by the correct receiving facility identifier.

4. The method as in claim 1, wherein the first set of data associated with an ASN includes at least one of a supplier code, an ASN number, a PO number, a part number, a part quantity, and a part price.

5. The method as in claim 1, wherein the second set of data includes at least one of a supplier code, a PO number, a part number, a part quantity, and a part price.

6. The method as in claim 1, wherein the ASN is an EDI 856 message according to the ANSI 12.x standard.

7. The method as in claim 1, further including creating a report listing the one or more misdirected ASNs.

8. The method as in claim 1, further including:
creating a report for each supplier who sends ASNs;
reporting for the supplier at least one of the number of misdirected ASNs, the total number of ASNs, the number of ASNs that were redirected, the number of ASNs that were not redirected, and the number of contacts with the supplier;
reporting for the supplier a supplier name and a supplier code; and
parsing the reported data by time periods.

9. A computer-readable medium including instructions for performing a method, when executed by a processor, for correcting misdirected Advanced Shipping Notices (ASNs), the method comprising:
receiving, from a product supplier, a first set of data associated with an ASN, wherein the first set of data includes an ASN receiving facility identifier;
determining a PO that is associated with the ASN, wherein the purchase order (PO) includes a second set of data;
comparing one or more fields of the first set of data with one or more fields of the second set of data;
determining if the ASN was misdirected based on the comparison; and
correcting the ASN, when it is determined that the ASN was misdirected.

10. The computer-readable medium of claim 9, wherein correcting the misdirected ASN is completed before delivery of material associated with the ASN.

11. The computer-readable medium of claim 9, wherein when it is determined that the ASN was misdirected to an incorrect ASN receiving facility, correcting the ASN further includes:
determining if a correct receiving facility, identified by a correct receiving facility identifier, is on the same communications network as an incorrect ASN receiving facility identified by an incorrect ASN receiving facility identifier;
changing, when the correct receiving facility is on the same communications network as the incorrect ASN receiving facility, the incorrect ASN receiving facility identifier to the correct receiving facility identifier; and
requesting, when the correct receiving facility is not on the same communications network as the incorrect ASN receiving facility, the product supplier to resend the ASN to the correct receiving facility identified by the correct receiving facility identifier.

12. The computer-readable medium of claim 9, wherein the first set of data associated with an ASN includes at least one of a supplier code, an ASN number, a PO number, a part number, a part quantity, and a part price.

13. The computer-readable medium of claim 9, wherein the second set of data includes at least one of a supplier code, a PO number, a part number, a part quantity, and a part price.

14. The computer-readable medium of claim 9, wherein the ASN is an EDI 856 message according to the ANSI 12.x standard.

15. The computer-readable medium of claim 9, further including creating a report listing the one or more misdirected ASNs.

16. The computer-readable medium of claim 9, the method further including:
creating a report for each supplier who sends ASNs;
reporting for the supplier at least one of the number of misdirected ASNs, the total number of ASNs, the number of ASNs that were redirected, the number of ASNs that were not redirected, and the number of contacts with the supplier;
reporting for the supplier a supplier name and a supplier code; and
parsing the reported data by time periods.

17. A system for correcting misdirected Advanced Shipping Notices (ASNs), comprising:
at least one memory storing data and instructions; and
at least one processor configured to access the memory and configured to, when executing the instructions:
receive, from a products supplier, a first set of data associated with an ASN, wherein the first set of data includes an ASN receiving facility identifier;
determine a purchase order (PO) that is associated with the ASN, wherein the PO includes a second set of data;
compare one or more fields of the first set of data with one or more fields of the second set of data;
determine if the ASN was misdirected based on the comparison;
determine if a correct receiving facility is on the same communications network as an incorrect ASN receiving facility; and
correct a misdirected ASN, including:
change, when the correct receiving facility is on the same communications network as the incorrect ASN receiving facility, the incorrect ASN receiving facility identifier to a correct receiving facility identifier; and
request, when the correct receiving facility is not on the same communications network as the incorrect ASN receiving facility, the product supplier to resend the ASN to the correct receiving facility identified by the correct receiving facility identifier.

18. The system as in claim 17, wherein the at least one processor is configured to complete the changing, requesting, and correcting of the misdirected ASN before delivery of material associated with the ASN.

19. The system as in claim 17, wherein the ASN is an EDI 856 message according to the ANSI 12.x standard.

20. The system as in claim 17, wherein the at least one processor is configured to:
create a first report listing one or more ASNs that were misdirected by being sent to an incorrect receiving facility;
create a second report for each supplier who sends ASNs;
report for the supplier at least one of the number of misdirected ASNs, the total number of ASNs, the number of ASNs that were redirected, the number of ASNs that were not redirected, and the number of contacts with the supplier;
report for the supplier a supplier name and a supplier code; and
parse the reported data by time periods.
